(19) United States
(12) Patent Application Publication
(10) Pub. No.: US 2026/0256112 A1
(43) Pub. Date: Sep. 3, 2026

(54) COMPACT ANIMAL FEED MIXER AND FEEDER

(71) Applicant: FARM AID EQUIPMENT, INC., Gothenburg, NE (US)

(72) Inventors: Lance Onan, Wauwatosa, WI (US); Caleb MacPherson, Gothenburg, NE (US)

(21) Appl. No.: 19/554,805

(22) Filed: Mar. 3, 2026

Related U.S. Application Data
(60) Provisional application No. 63/766,358, filed on Mar. 3, 2025.

(51) Int. Cl. A01K 5/00; A23N 17/00; B01F 27/07; B01F 27/112; B01F 27/1145; B01F 27/70; B01F 27/72; B01F 33/501; B01F 35/22; B01F 35/32; B01F 35/75; B01F 101/18

(52) U.S. Cl. CPC A01K 5/002; A23N 17/007; B01F 27/073; B01F 27/112; B01F 27/1145; B01F 27/70; B01F 27/72; B01F 33/5013; B01F 35/2205; B01F 35/3204; B01F 35/751; B01F 35/754551; B01F 2101/18; B01F 2215/0481

(57) ABSTRACT

A compact animal feed mixer and feeder designed for installation on vehicles such as pickup truck beds, front loaders, or bobcats. The invention includes a mixing chamber with a discharge door, a paddle assembly mounted to a mixing reel, and a compact drive train assembly that reduces high input speeds from 3600 RPM to approximately 4 RPM. An internal combustion engine provides the power for mixing and driving a conveyor that transfers feed from the discharge door to feed bunks or directly onto the ground. A wireless remote control enables remote operation of the motor, mixing mechanism, and door actuation. A lightweight C-channel frame supports the structure, and door movement is actuated by an electric linear actuator.

### CROSS-REFERENCE TO RELATED APPLICATIONS

This application claims the benefit of U.S. Provisional Application No. 63/766,358 filed on Mar. 3, 2025, which is incorporated herein by reference in its entirety.

### TECHNICAL FIELD

The present invention generally relates to animal feed mixers and, more particularly, to a compact animal feed mixer and feeder that is designed for use in environments where space is limited. The invention is ideal for use on for example, the back of a pickup truck, front loader, or bobcat while providing enhanced control and ease of maintenance.

### BACKGROUND OF THE INVENTION

Conventional animal feed mixers are designed for larger, stationary installations or pull-behind trailers or dedicated vehicles. The typically have two or more large reels extending along the length of the mixing chamber. The reels are driven by a motor, which rotates within the chamber to mix the feed.

Large mixers also have large drive trains that rotate the reel, which has a large gear ring. Due to the mixer's size, there is room to house the gear ring and drive train. The reels rotate within the mixing chamber to push and pull the ingredients horizontally, facilitating mixing as materials move along the length of the mixer. Due to the size of the mixing chamber, the reels can rotate and mix material.

These systems are large, heavy devices. Installing them requires dedicated space, which isn't always available. Farms may need to invest in ancillary infrastructure improvements, such as reinforced flooring or dedicated power sources, to support the feeder system. Pull behind and dedicated feeders require storage that may not be readily available, and a dedicated trailer or vehicle.

One of the primary drawbacks of large horizontal animal feeders is the financial commitment required. The upfront cost of purchasing and installing such a system can be significant, making them less accessible to smaller or budget-conscious operations. While designed for heavy use, the complexity of these machines means that specialized maintenance and occasional repairs may be costly.

There is a need for a compact animal feed mixer that is less expensive, easy to store, and can be mounted on for example, the back of a pickup truck, front loader, or bobcat. There is also a need for a self-contained animal feed mixer with remote control operation and ease of maintenance.

### SUMMARY OF THE INVENTION

The present invention provides a compact animal feed mixer and feeder that can be readily installed on various vehicles without interfering with their primary functions. The animal feed mixer and feeder of the present invention has a mixing chamber with a discharge door and a uniquely mounted reel and paddle assembly. The paddles are attached by a pivot mechanism to a mixing reel, which distributes force more evenly.

Discharge paddles are mounted on shafts on the reel. The paddles are mounted to pivot against a bias in the event of a jam. In large mixers with a higher hay ratio, there is room to mount the springs and mounting points, and due to the larger hay ratio, jamming of the paddles is less of a problem. But in a small compact mixer and spreader, jamming is a problem.

It has a compact drivetrain assembly that reduces a high input speed (3600 RPM) to a much lower operating speed (approximately 4 RPM), with all components scaled down for compactness.

In the disclosed embodiment, an internal combustion engine or motor powers the mixing and conveyor functions without needing external vehicle connections. A wireless remote-control system enables remote operation of the mixer's functions, including motor on/off, mixer engagement/disengagement, and door actuation.

An electric linear actuator replaces traditional hydraulics for door movement. The actuator is powered by a battery charged by the motor, ensuring full functionality even when mounted on a vehicle.

The conveyor transfers feed from the discharge door to the feed bunks or ground. The entire assembly is supported by a lightweight yet sturdy C-channel frame, facilitating ease of transport and installation.

The overall design features access panels that can be quickly removed, in the disclosed embodiment, they are secured with thumbscrews, providing straightforward entry to internal parts. This ease of maintenance reduces downtime and extends the lifespan of the mixer by making routine servicing and repairs simpler and less time-consuming.

Farmers and livestock operators are increasingly required to work within confined spaces, whether on small farms or when retrofitting equipment to mobile platforms like pickup trucks, front loaders, or bobcats. This compact design saves valuable space on the farm. It allows for greater flexibility in choosing where and how the equipment is used, particularly in environments where space is at a premium.

A need for versatile, mobile equipment characterizes the modern farming landscape. The reduced dimensions and streamlined design of the present invention allows it to be easily mounted and removed without affecting the vehicle's primary functions. This versatility means that operators can move the mixer between different work sites or farming operations with minimal hassle, providing a flexible solution for diverse operational requirements.

As farms continue to adapt to tighter spaces and increasing demands for efficiency, the horizontal mixer of the present invention offers a practical and innovative solution that combines technical advancements with everyday usability.

### BRIEF DESCRIPTION OF THE DRAWINGS

FIG. 1 is a perspective view of the feed mixer and feeder of the present invention.

FIG. 2 is a partially exploded view of FIG. 1.

FIG. 3 is a partially exploded rear view of FIG. 1.

FIG. 4 is a perspective view of the drive train assembly.

FIG. 4A is a schematic view of the drive train assembly.

FIG. 5 is a partial side view of the reel and paddle assembly.

FIG. 6 is a partial side view of the reel and paddle assembly.

FIG. 7 is a partial perspective view of the reel and paddle assembly.

FIG. 8 is a partial perspective view of the reel and paddle assembly.

FIG. 9 is a partial perspective view of the reel and paddle assembly.

FIG. 10 is a perspective view of a second embodiment of the reel.

FIG. 11 shows the remote.

FIG. 12 is a perspective view of the frame.

FIG. 13 is a perspective view of the feeder with doors removed.

FIG. 14 is a perspective view of the baler attachment

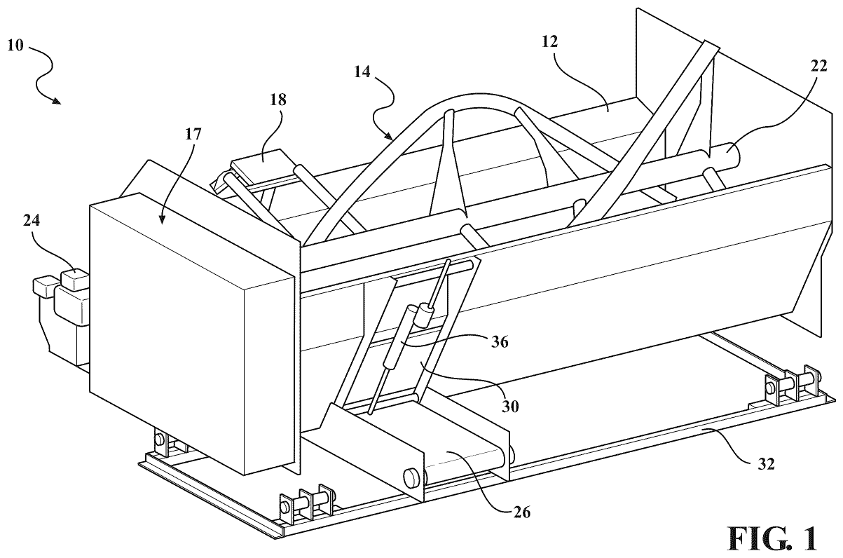

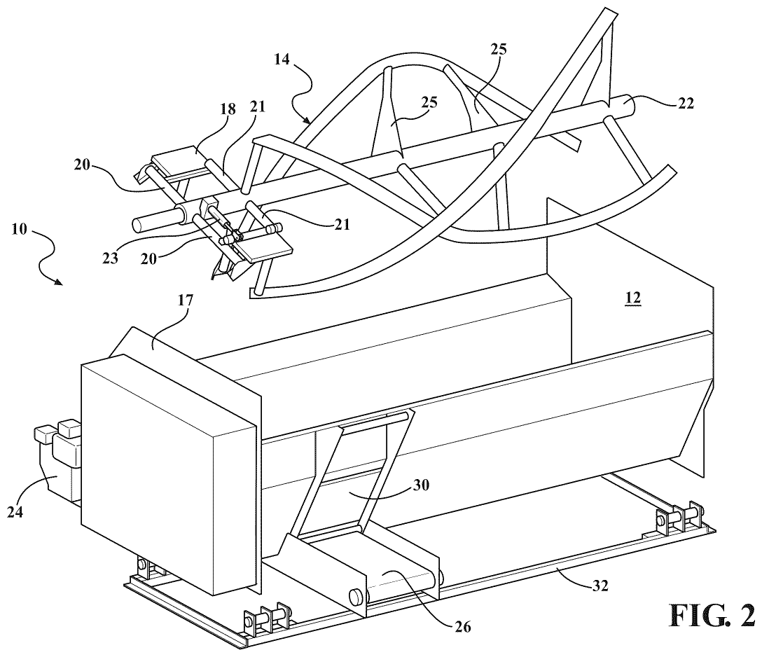

### DETAILED DESCRIPTION OF THE INVENTION

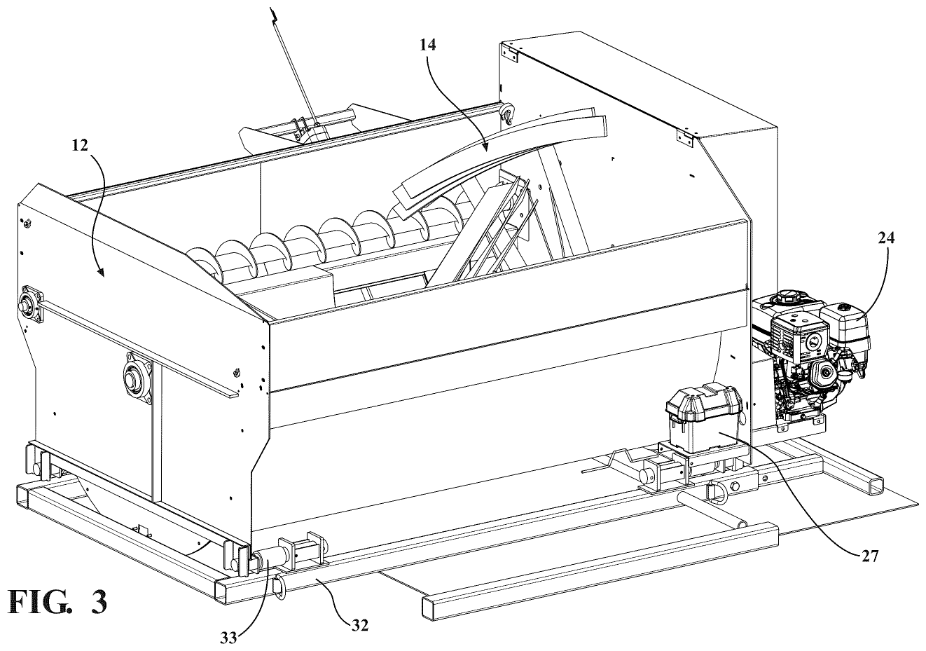

The compact animal feed mixer and feeder of the present invention is generally shown at 10. The mixing chamber 12 houses feed materials, which are agitated by a reel 14 and a return auger 11 mounted within the mixing chamber 12. In the disclosed embodiment, the mixing chamber is approximately 105 cubic feet, with a 50-inch diameter at the top and is 7 feet long. The return auger 11 can be seen in FIG. 3. In the disclosed embodiment, the interior of the mixing chamber 12 is coated with PVC. The exterior of the mixing chamber 12 is disclosed as metal, such as, for example, steel. It will be appreciated by those of ordinary skill in the art that the mixing chamber 12 could be for example made of plastic, fiberglass or reinforced fiberglass instead of steel.

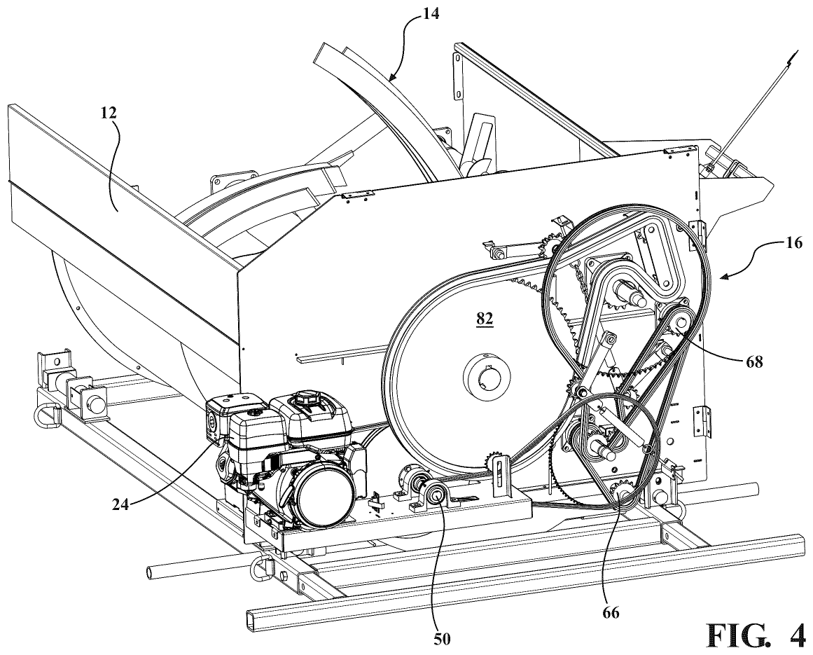

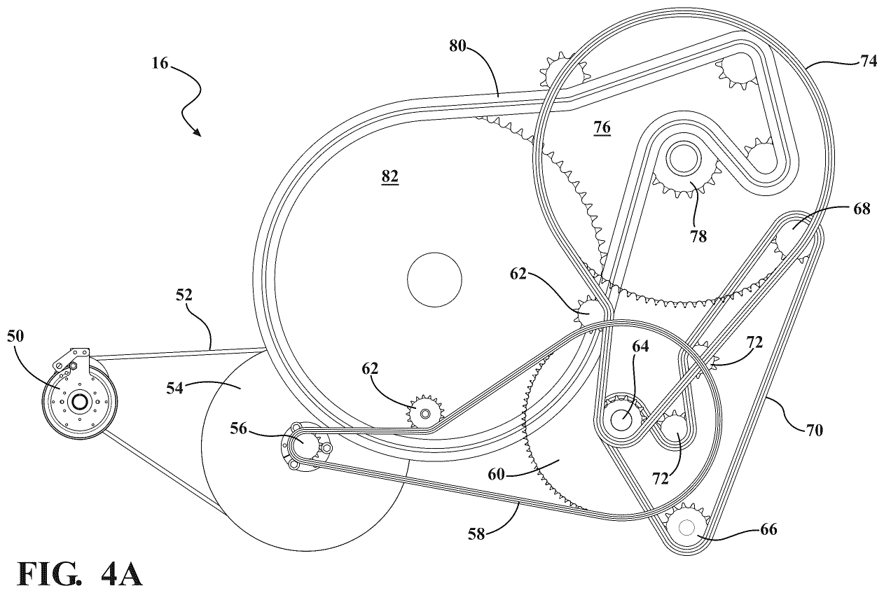

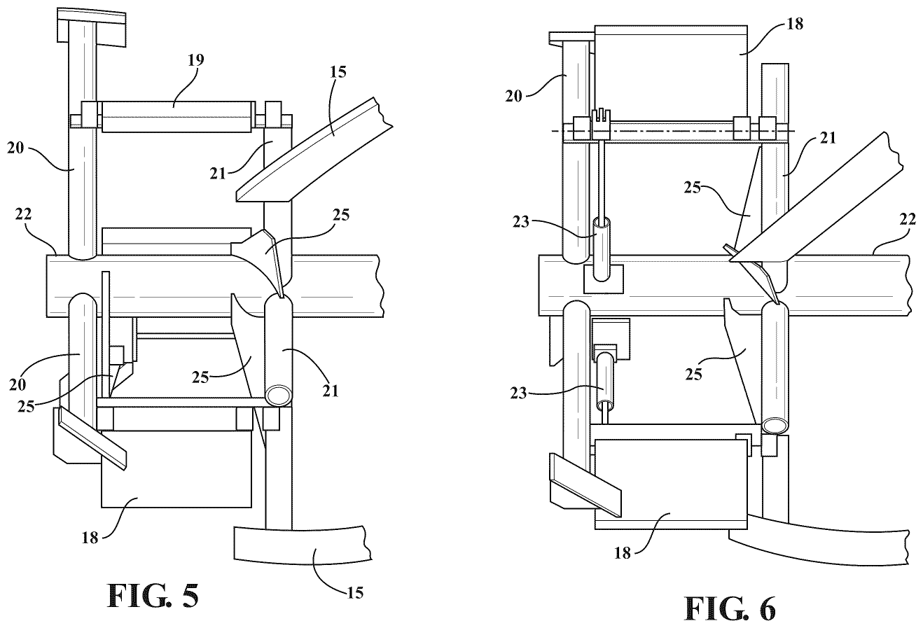

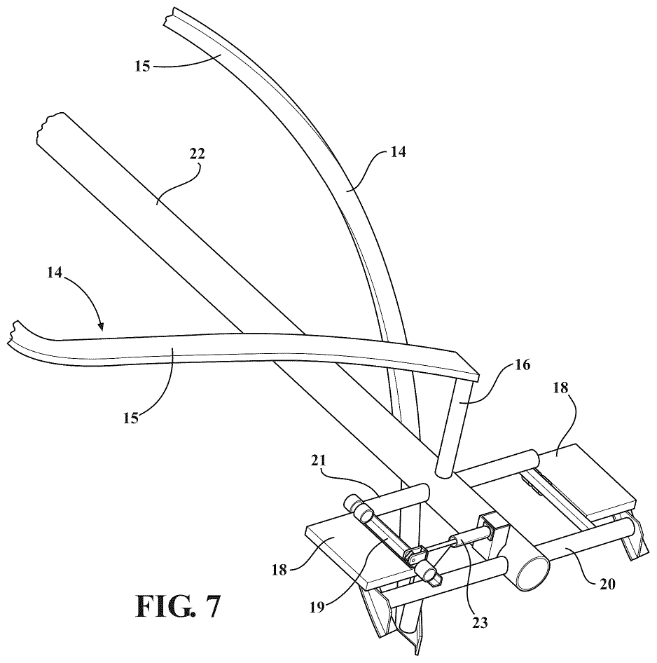

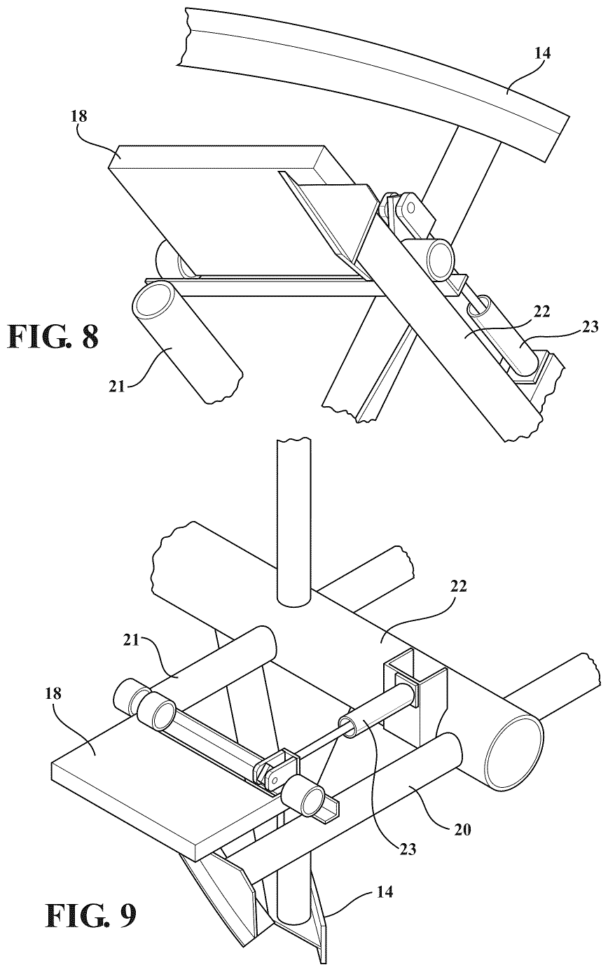

The reel 14 moves material in the chamber 12 in the direction of a discharge or feed door 30. The return auger 15 moves material in the opposite direction away from the feed door 30. In this way, the material is moved both ways in the mixing chamber to ensure thorough mixing and movement of all the material to and out of the feed door 30. The reel 14 is rotated by the drive train assembly 16, see FIGS. 4 and 4A. The drive train assembly 16 is enclosed within housing 17.

In a first embodiment, a paddle assembly 18 is pivotally mounted to a pair of shafts 20 and 21 that transversally extends from the drive pipe 22 of the reel 14. See Figures (insert). This configuration ensures that, in the event of a jam, the force exerted across the paddle face remains even. Moreover, the design minimizes the need for extensive hardware, thereby conserving space. The paddles can be spring biased with a coil or leaf spring, a torsional rubber spring, or a spring loaded cylinder or hydraulic cylinder 23 etc.

Each paddle 18 is mounted to a pivot axis 19, which is mounted between shafts 20 and 21. The paddle 18 is mounted to the pivot axis 19. A biasing spring 23 extends between the drive pipe 22 and the pivot axis 19. It will be understood by those of ordinary skill in the art that other bias mixing means could be used, such as, for example, a torsional spring or a torsional insert into the pivot axis 19.

The paddles 18 are biased to a position generally parallel to the shafts 20 and 21 to engage and mix the feed in the mixing chamber 12 and to push feed through the discharge or feed door 30 to a conveyor 26. In the event a paddle 18 engages material that is jammed, the paddle 18 pivots on the pivot axis 19 against bias 23 to prevent damage to the mechanism.

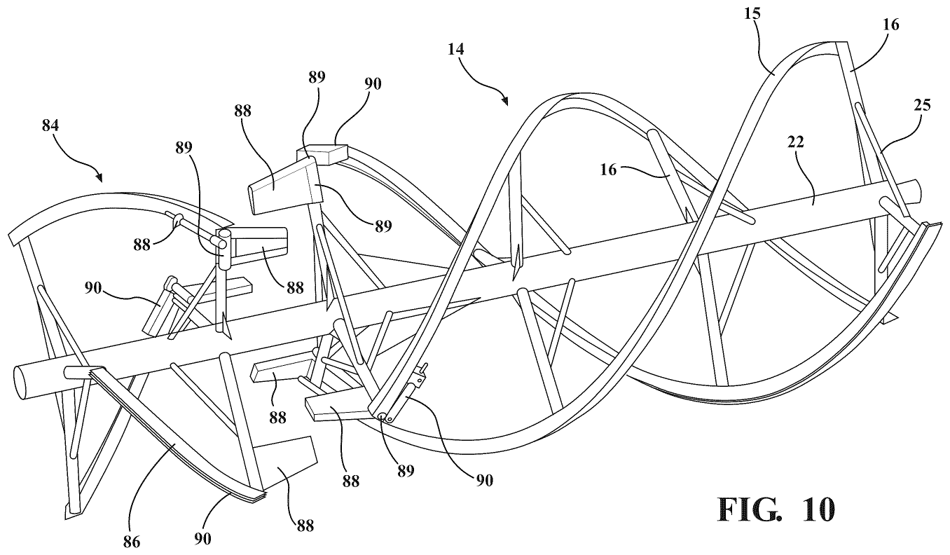

The reel 14 has curved or helical blades 15 mounted to support arms or spokes 16, which extend from the drive pipe 22. The spokes 16 as shown are reinforced with spoke gussets 25. With reference to FIG. 10, each helical blade 15 has a ribbon 27 mounted to its exterior surface. The ribbon 27 can be made of rubber, pvc, etc. The ribbon 27 wipes the inside of the mixing chamber 12 to ensure that all the material is mixed and directed to the feed door 30. In use, almost all the material in the mixing chamber 12 can be discharged from the chamber 12 due to the ribbons 27. The reel 14 includes a spiral face 29 and a wiper hold down 31.

Given the constraints of mounting the mixer on a pickup truck or similar vehicle, the drive train assembly 16 must be small yet effective. The drive train 16 is optimized to reduce input speed from 3600 RPM to approximately 4 RPM without compromising the mixing action.

The design includes a compact drive train 16 that converts high input speeds to the lower operational speeds required for thorough mixing. This energy-efficient approach not only reduces power consumption but also minimizes wear and tear on the system, contributing to lower maintenance costs over time. The drive train assembly 16 will be described in greater detail below.

A compact internal combustion engine or motor 24 provides power for both the reel 14, return auger 11, and the conveyor 26 that transfers feed to the designated feed bunks or ground. The system is designed so that installation or removal of the mixer does not interfere with the vehicle's primary functions.

With reference to FIG. 4A, the drive train assembly 16 is shown. The motor 24 is connected to a power input pulley and clutch 50. An input belt 52 connects the pulley and clutch 50 to a speed reduction pulley 54. An input sprocket 56 is connected to the pulley 54. A first speed-reduction chain 58 connects the input sprocket 56 to an output sprocket 60. Tension sprockets 62 are provided. An accessory input sprocket 64 is mounted to the output sprocket 60. Accessory input sprocket 64 has a first and a second sprocket. The first sprocket of the accessory input sprocket 64 drives the discharge conveyor drive sprocket 66 and the return auger drive sprocket 68. An accessory chain line 70 connects the first sprocket of the accessory input sprocket 64, the discharge conveyor drive sprocket 66, and the return auger drive sprocket 68. The discharge conveyor drive sprocket 66 is operatively connected to the conveyor 26. The return auger drive sprocket 68 is operatively connected to the return auger 15. Idler sprockets 72 are provided.

A second speed-reduction chain 74 is driven by the second sprocket of the accessory input sprocket 64. The second speed-reduction chain 74 is connected to a chain output sprocket 76. A final drive input sprocket 78 is mounted to the chain output sprocket 76. A spiral drive chain or reel drive chain 80 connects the final drive input sprocket 78 to the final drive sprocket 82. The final drive sprocket 82 is operatively connected to the reel 14.

With reference to FIG. 10, a second embodiment of the reel 14 is illustrated. In this embodiment, a second feed discharge reel 84 is mounted to the drive pipe 22. The second feed discharge reel 84 has helical blades 86 which overlap the helical blades 15. The overlapped portion of the blades 86 and 15 is adjacent to the discharge or feed door 30. In the disclosed embodiment, the overlap is approximately 10 inches. The overlapped blades 86 fand 15 force the material in the mixing chamber 12 through the discharge 30. In the disclosed embodiment, blade paddles 88 are pivotally mounted to the overlapped ends of the blades 15 and 86 to facilitate the movement of material through the discharge door 30. The blade paddles 88 are mounted upon a pivot axis 89 attached to the discharge reel 84. Each paddle 88 is biased to allow it to move in the event of material jamming. In the disclosed embodiment, the bias is a spring-loaded connecting rod 90. It will be understood by those of ordinary skill in the art that other biasing methods could be used, such as a torsional spring, a torsional rubber mount, etc.

The mixer 10 is supported by a lightweight C-channel frame 32 that provides sufficient structural integrity while allowing easy handling and installation, see FIG. 12. The C-channel frame can be mounted on a Bobcat-style loader, a pickup truck bed, or a wagon, etc. In the disclosed embodiment, weighing scales shown generally at 33 can be used to accurately control the feed distribution.

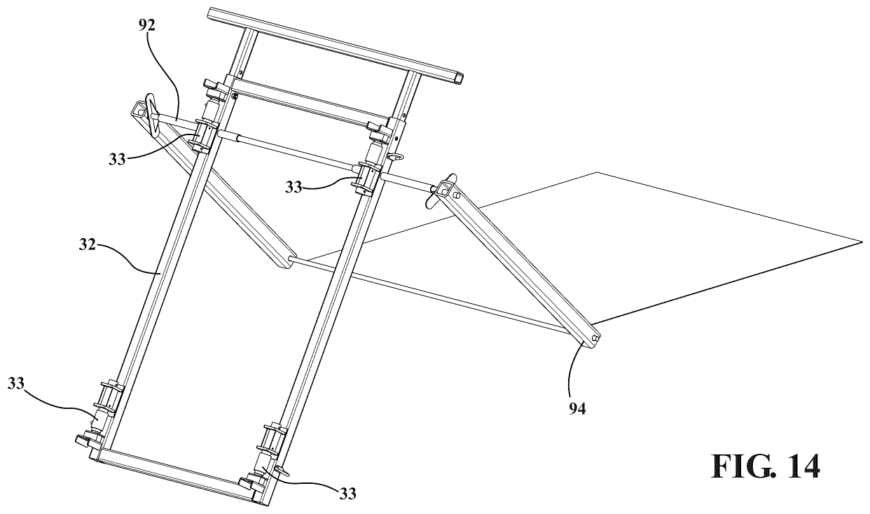

With reference to FIG. 14 a unique bailor loading attachment is illustrated. In the disclosed embodiment, mounting ears 92 protrude from the C-channel frame 32. Various connectors can be attached to the ears 92 to allow the arms 94 of a bailor to connect to the mixer 10. The bailor arms can then be raised to mount the mixer 10 onto the bed of a vehicle and lowered to remove the mixer 10 from the vehicle.

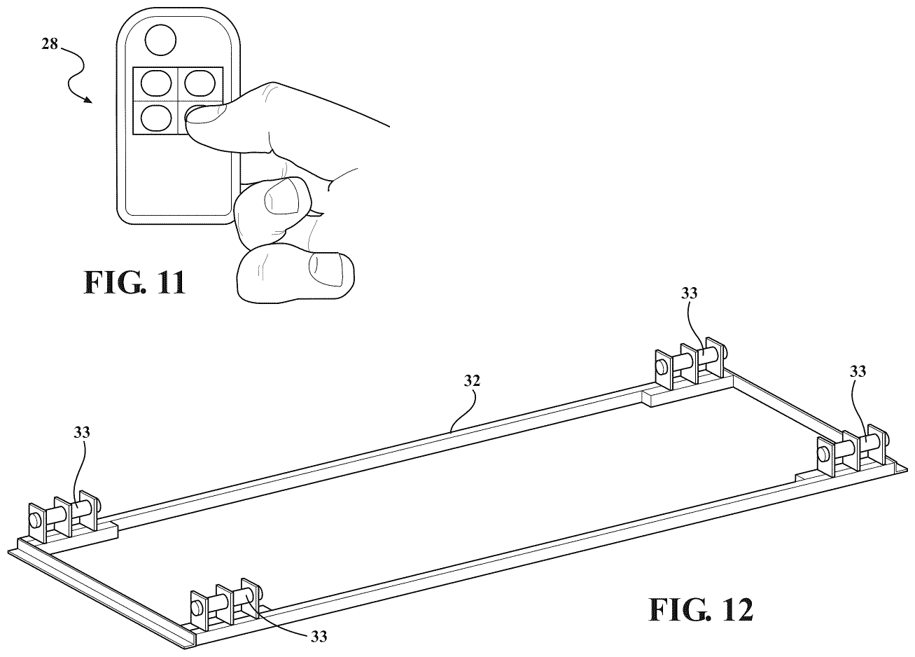

With reference to FIG. 11, a wireless remote control 28 enables the operator to perform functions such as motor on/off, mixer engagement/disengagement, and feed door 30 actuation.

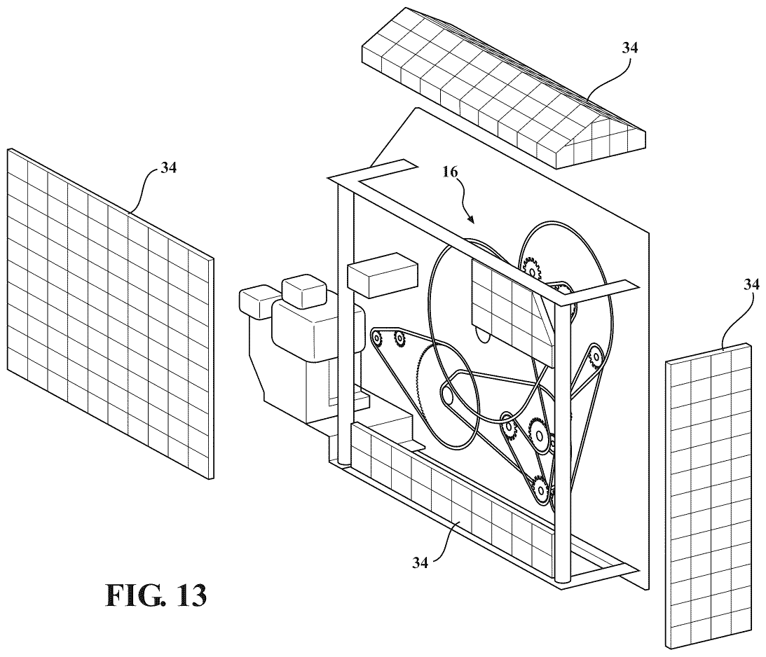

With reference to FIG. 13, to facilitate access to internal components, especially in environments where a swinging door is impractical, access panels 34 are secured with thumbscrews for quick removal.

An electric linear actuator 36 controls the movement of the discharge or feed door 30, eliminating the need for a hydraulic system. The actuator is battery-powered, with battery 25, and its charging is integrated into the system via motor 24.

The compact animal feed mixer and feeder 10 described herein provides a novel solution for mixing and delivering animal feed in space-constrained environments. By incorporating a uniquely arranged paddle assembly 18 of 88, an efficient drive train 16, a self-contained motor 24, and a wireless remote control system 28, the invention overcomes limitations associated with traditional feed mixers and provides enhanced operational flexibility and ease of maintenance.

The foregoing invention has been described in accordance with the relevant legal standards. Thus, the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A compact animal feed mixer and feeder comprising:
a mixing chamber;
an reel mounted within said mixing chamber for rotation with respect to said mixing chamber;
an auger
a motor connected to said reel;
a discharge door positioned on said mixing chamber;
a paddle assembly mounted to said reel adjacent said discharge door, said paddle assembly having at least one paddle pivotally mounted to a pivot axis,
whereby said reel mixes material within said mixing chamber and pushes material to said discharge door and said auger pushes material away from said discharge door.

2. The compact animal feed mixer and feeder of claim 1, wherein said paddle assembly includes at least one shaft connected between said reel and said pivot axis, said at least one shaft extending transversely to said at least one shaft;
said paddle extends transversely to said at least one shaft and is biased to a normal position that is generally parallel to said at least one shaft and pivotable to a second position;
whereby said paddle can pivot to avoid damage as said reel rotates, said paddle and reel mix animal feed, and said paddle forces feed from said mixing chamber through said discharge door.

3. The compact animal feed mixer and feeder of claim 1, wherein said reel includes a drive pipe operatively connected to said motor to rotate said drive pipe, and at least one blade extending from said drive pipe.

4. The compact animal feed mixer and feeder of claim 2, wherein said blade is curved along the length of said drive pipe.

5. The compact animal feed mixer and feeder of claim 2, wherein said drive pipe extends the length of said mixing chamber.

6. The compact animal feed mixer and feeder of claim 2, further including support arms extending between said drive pipe and said blade to said drive pipe.

7. The compact animal feed mixer and feeder of claim 2, wherein said motor is an internal combustion engine.

8. The compact animal feed mixer and feeder of claim 2, wherein said shaft is connected to said drive pipe.

9. The compact animal feed mixer and feeder of claim 1, wherein said discharge door includes a linear actuator to open and close said door.

10. The compact animal feed mixer and feeder of claim 1, further including a wireless remote control for remotely controlling the motor, reel, and discharge door.

11. The compact animal feed mixer and feeder of claim 1, further including a C-channel frame upon which said mixing chamber is mounted.

12. The compact animal feed mixer and feeder of claim 1, further including a conveyor mounted adjacent to said discharge door.

13. The compact animal feed mixer and feeder of claim 1, further including a drive train interconnected to said reel and conveyor.

14. The compact animal feed mixer and feeder of claim 1, further including a drive train operatively connected to said motor, said drive train reduces the input speed from 3600 rpm to about 4 rpm.

15. The compact animal feed mixer and feeder of claim 1, wherein said feeder is scaled to fit within the limited spatial constraints of vehicular platforms such as pickup truck beds, front loaders, or bobcats.

16. The compact animal feed mixer and feeder of claim 1, further including an attachment ear for receipt of bailor arms to load and unload said animal feed mixer and feeder.

17. A compact animal feed mixer and feeder comprising:
a mixing chamber;
a reel mounted within said mixing chamber for rotation with respect to said mixing chamber;
an internal combustion engine connected to said reel;
a discharge door positioned on said mixing chamber;
a drive train interconnected to said reel and conveyor;
said drive train operatively connected to said internal combustion engine, said drive train reduces the input speed from 3600 rpm to about 4 rpm.

18. The compact animal feed mixer and feeder of claim 17, further including a paddle assembly mounted to said reel adjacent said discharge door, said paddle assembly having at least one paddle pivotally mounted to a pivot axis, at least one shaft connected between said reel and said pivot axis, said at least one shaft extending transversely to said at least one shaft;
said paddle extends transversely to said at least one shaft and is biased to a normal position that is generally parallel to said at least one shaft and pivotable to a second position;
whereby said paddle can pivot to avoid damage as said reel rotates, said paddle and reel mix animal feed, and said paddle forces feed from said mixing chamber through said discharge door.

19. The compact animal feed mixer and feeder of claim 17, further including a second feed discharge reel mounted adjacent said reel and said discharge door, said second feed discharge reel overlaps said reel adjacent said discharge door to force material in the mixing chamber through said discharge door.

20. The compact animal feed mixer and feeder of claim 19, further including blade paddles pivotally mounted to the overlapped ends of said discharge reel and said reel to facilitate the movement of material through the discharge door.

21. The compact animal feed mixer and feeder of claim 20 wherein said blade paddles are mounted upon a pivot axis attached to said discharge reel to allow said blade paddles to move in the event of material jamming.

22. The compact animal feed mixer and feeder of claim 17, wherein said discharge door includes a linear actuator to open and close said door.

23. The compact animal feed mixer and feeder of claim 17, further including a wireless remote control for remotely controlling the motor, reel, and discharge door.

24. The compact animal feed mixer and feeder of claim 17, further including a C-channel frame upon which said mixing chamber is mounted.

25. The compact animal feed mixer and feeder of claim 17, further including a conveyor mounted adjacent to said discharge door.

26. The compact animal feed mixer and feeder of claim 17, is scaled to fit within the limited spatial constraints of vehicular platforms such as pickup truck beds, front loaders, or bobcats.

27. The compact animal feed mixer and feeder of claim 17, further including an attachment ear for receipt of bailor arms to load and unload said animal feed mixer and feeder.
